(19) United States
(12) Patent Application Publication
(10) Pub. No.: US 2014/0053403 A1
(43) Pub. Date: Feb. 27, 2014

(54) METHOD FOR EXTENDING AN ORIGINAL SERVICE LIFE OF GAS TURBINE COMPONENTS

(71) Applicants: Joseph Vincent Pawlowski, Phoenix, AZ (US); Srinivas Venkatappa, Bangalore (IN); Sudip Kumar Sinha, Bangalore (IN)

(72) Inventors: Joseph Vincent Pawlowski, Phoenix, AZ (US); Srinivas Venkatappa, Bangalore (IN); Sudip Kumar Sinha, Bangalore (IN)

(73) Assignee: GENERAL ELECTRIC COMPANY, Schenectady, NY (US)

(21) Appl. No.: 13/591,726

(22) Filed: Aug. 22, 2012

(51) Int. Cl. B23P 6/00

(52) U.S. Cl. 29/888.021

(57) ABSTRACT

A method for extending a service life of a gas turbine component includes identifying the service life for the component and comparing a characteristic of the component to a predetermined departure parameter. The method further includes refurbishing the component to a predetermined specification if the characteristic of the component satisfies the predetermined departure parameter and establishing an extended service life for the component.

### FIELD OF THE INVENTION

The present invention generally involves a method for extending an original service life of gas turbine components. In particular embodiments, the method may result in a departure enabled extended service life and/or a condition based revised service life for one or more components in the gas turbine.

### BACKGROUND OF THE INVENTION

Gas turbines are widely used in industrial and commercial operations. A typical gas turbine includes a compressor at the front, one or more combustors around the middle, and a turbine at the rear. The compressor imparts kinetic energy to the working fluid (e.g., air) to produce a compressed working fluid at a highly energized state. The compressed working fluid exits the compressor and flows to the combustors where it mixes with fuel and ignites to generate combustion gases having a high temperature and pressure. The combustion gases flow to the turbine where they expand to produce work. For example, expansion of the combustion gases in the turbine may rotate a shaft connected to a generator to produce electricity.

Operation of the gas turbine exposes the various components to substantial thermal, mechanical, hydraulic, and other forms of wear and degradation. As a result, each component in each gas turbine model typically has a service life beyond which the component should be replaced or otherwise removed from service to ensure continued operation without unscheduled outages. The service life may be measured according to various parameters that reliably reflect, predict, and/or indicate the amount of wear and degradation experienced by the component and thus the ability that the component will operate satisfactorily until the next scheduled outage. For example, the service life of a component may be expressed in terms of the total operating hours for the component, the number of transient operations such as startups and/or shutdowns that the component has undergone, the number of defects found in the component during inspections, the number of times that the component has been repaired or refurbished, the physical dimensions of the component, and/or any other measurable criteria associated with the component that may be used as a reliable precursor of the component's risk of failure before the next scheduled outage.

Occasionally, a customer may desire to operate one or more components beyond the service life for the component. For example, a component may be approaching the service life, but a replacement component may not be available or an outage may not be planned before the component reaches or exceeds the service life. In some instances, the amount of historical data associated with the operation, environment, repair, and/or maintenance history of the component may be sufficient to support an engineering review to determine if the service life may be revised for the particular component in a particular gas turbine model. Once the engineering review is completed, the component may be assigned a revised service life, allowing approved continued use of the component beyond the previous service life. In other instances, however, the number of gas turbines in a particular model, the historical data associated with the specific component, and/or the ability to perform the engineering review may not be sufficient to determine a revised service life for the particular component. As a result, the customer may not be able to operate the gas turbine without exceeding the current service life for one or more components. Therefore, a method for extending the service life of gas turbine components that does not require a revised service life may be useful.

### BRIEF DESCRIPTION OF THE INVENTION

Aspects and advantages of the invention are set forth below in the following description, or may be obvious from the description, or may be learned through practice of the invention.

One embodiment of the present invention is a method for extending a service life of a gas turbine component. The method includes identifying the service life for the component and comparing a characteristic of the component to a predetermined departure parameter. The method further includes refurbishing the component to a predetermined specification if the characteristic of the component satisfies the predetermined departure parameter and establishing an extended service life for the component.

Another embodiment of the present invention is a method for extending a service life of a gas turbine component that includes identifying the service life for the component and comparing a plurality of characteristics of the component to a plurality of predetermined departure parameters. The method further includes refurbishing the component to a predetermined specification if no more than one of the plurality of characteristics of the component fails to satisfy the plurality of predetermined departure parameters and establishing an extended service life for the component.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a cross section view of an exemplary gas turbine;

FIG. 2 is an exemplary flow chart of a method for extending the service life of a gas turbine component according to one embodiment of the present invention; and

FIG. 3 is an exemplary service life matrix for gas turbine components according to various embodiments of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a method for extending a service life of one or more gas turbine components. In particular embodiments, the method may result in a departure enabled extended service life and/or a condition based revised service life for one or more components in the gas turbine. As used herein, the term “service life” refers to one or more measurable criteria assigned to a component that indicate when the component should be replaced or otherwise removed from service. The modifier “extended” applied to the term “service life” refers to an approved use of the component beyond the service life of the component. The modifier “revised” applied to the term “service life” refers to a new service life established after an engineering analysis of the use and operation of the particular component or gas turbine that replaces the previous service life for the component or gas turbine. Although exemplary embodiments of the present invention will be described generally in the context of components incorporated into a gas turbine for purposes of illustration, one of ordinary skill in the art will readily appreciate that embodiments of the present invention may be applied to any component and are not limited to a gas turbine component unless specifically recited in the claims.

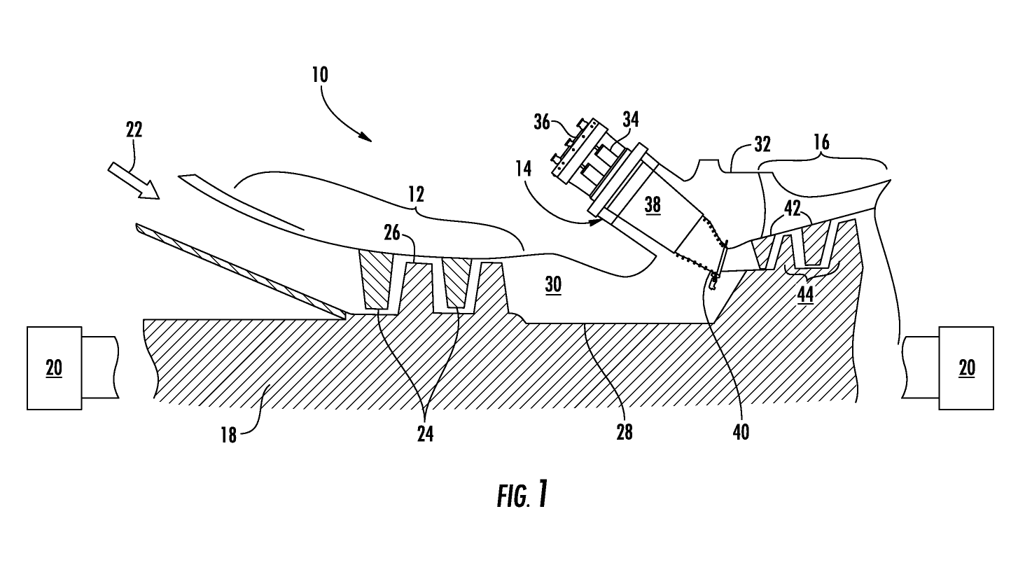

FIG. 1 provides a simplified cross-section view of an exemplary gas turbine 10 that may incorporate various embodiments of the present invention. As shown, the gas turbine 10 may generally include a compressor 12 at the front, one or more combustors 14 radially disposed around the middle, and a turbine 16 at the rear. The compressor 12 and the turbine 16 may share a common rotor 18 connected to a generator 20 to produce electricity.

The compressor 12 may be an axial flow compressor in which a working fluid 22, such as ambient air, enters the compressor 12 and passes through alternating stages of stationary vanes 24 and rotating blades 26. A compressor casing 28 contains the working fluid 22 as the stationary vanes 24 and rotating blades 26 accelerate and redirect the working fluid 22 to produce a continuous flow of compressed working fluid 22. The majority of the compressed working fluid 22 flows through a compressor discharge plenum 30 to the combustor 14.

The combustor 14 may be any type of combustor known in the art. For example, as shown in FIG. 1, a combustor casing 32 may circumferentially surround some or all of the combustor 14 to contain the compressed working fluid 22 flowing from the compressor 12. One or more fuel nozzles 34 may be radially arranged in an end cover 36 to supply fuel to a combustion chamber 38 downstream from the fuel nozzles 34. Possible fuels include, for example, one or more of blast furnace gas, coke oven gas, natural gas, vaporized liquefied natural gas (LNG), hydrogen, and propane. The compressed working fluid 22 may flow from the compressor discharge passage 30 along the outside of the combustion chamber 38 before reaching the end cover 36 and reversing direction to flow through the fuel nozzles 34 to mix with the fuel. The mixture of fuel and compressed working fluid 22 flows into the combustion chamber 38 where it ignites to generate combustion gases having a high temperature and pressure. A transition duct 40 circumferentially surrounds at least a portion of the combustion chamber 38, and the combustion gases flow through the transition duct 40 to the turbine 16.

The turbine 16 may include alternating stages of rotating buckets 42 and stationary nozzles 44. As will be described in more detail, the transition duct 40 redirects and focuses the combustion gases onto the first stage of rotating buckets 42. As the combustion gases pass over the first stage of rotating buckets 42, the combustion gases expand, causing the rotating buckets 42 and rotor 18 to rotate. The combustion gases then flow to the next stage of stationary nozzles 44 which redirect the combustion gases to the next stage of rotating buckets 42, and the process repeats for the following stages.

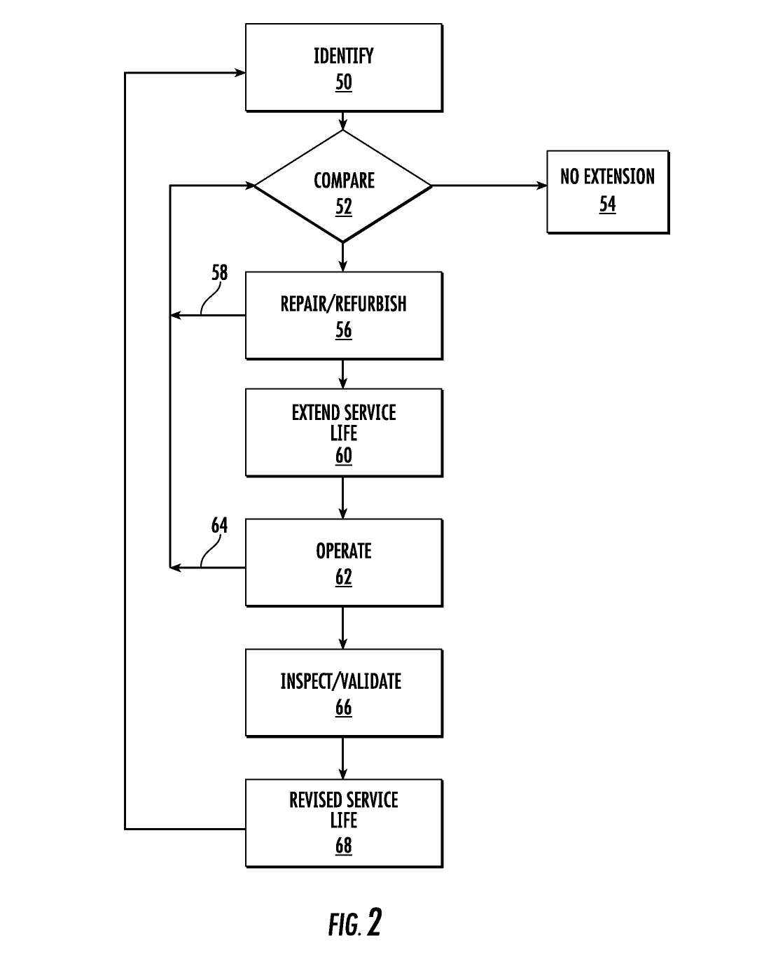

FIG. 2 provides an exemplary flow chart of a method for extending the service life of a gas turbine component according to one embodiment of the present invention. The gas turbine component may be one or more of the high value or critical components generally described with respect to FIG. 1 or any other component incorporated into the gas turbine. At block 50, the method identifies the current service life in effect for the component. The service life may be measured according to various parameters that reliably reflect, predict, and/or indicate the amount of wear and degradation experienced by the component and thus the ability that the component will operate satisfactorily until the next scheduled outage. In particular embodiments, the service life may be expressed in terms of the total operating hours for the component, the number of transient operations such as startups and/or shutdowns that the component has undergone, the number of defects found in the component during inspections, the number of times that the component has been repaired or refurbished, the physical dimensions of the component, and/or any other measurable criteria associated with the component that may be used as a reliable precursor of the component's risk of failure before the next scheduled outage.

At block 52, the method compares one or more characteristics of the component to associated predetermined departure parameters to determine if the component is a suitable candidate for an extended service life. The characteristics of the component and associated predetermined departure parameters may include any manufacturing, operational, repair, or historical indicia of the component's ability to continue to operate satisfactorily beyond the service life. The predetermined departure parameters may be specific limits for the associated component characteristics that may permit an extended service life if satisfied or preclude an extended service life if not satisfied. For example, environmental conditions such as humidity, temperature, and pollution levels may significantly impact a component's service life. In particular embodiments, the location where the component has been operated may be compared against a predetermined set of locations to determine if the location of the component's use may permit or preclude an extended service life. Alternately or in addition, a repair history for the component may indicate that the particular component has already undergone a higher number of repairs and/or more extensive repairs than would be prudent for extending the service life of the component. As another example, the specific dimensions of the component may be compared against predetermined dimensions to determine if the component is capable of being restored to acceptable dimensions to support an extended service life. Similarly, a repair history and/or operating history for the gas turbine in which the component is incorporated may be another characteristic of the component to be compared against the predetermined departure parameters to determine if an extended service life for the component is available. The preceding list of characteristics and predetermined departure parameters is not meant to be an exhaustive list, and one of ordinary skill in the art will readily appreciate from the teachings herein that the characteristics and associated predetermined parameters may include any other manufacturing, operational, and/or repair data associated with either the component or the gas turbine in which the component is incorporated.

The comparison performed in block 52 determines if an extended service life is available for the component based on one or more of the predetermined departure parameters being met. In particular embodiments, the comparison may require that one, some, or all of the predetermined departure parameters are satisfied before allowing an extended service life, depending on various factors associated with the particular component involved. For example, for particular components that have no effect on the safe operation of the gas turbine, the comparison performed in block 52 may reject an extended service life, indicated by block 54, if one or more of the predetermined departure parameters are satisfied, even though one or more other predetermined departure parameters are not satisfied. Conversely, for particular components that may be more critical to the safe operation of the gas turbine, the comparison performed in block 52 may require that all of the predetermined departure parameters are satisfied before allowing an extended service life.

If the comparison performed in block 52 determines that an extended service life is allowed, the method proceeds with refurbishing and/or repairing the component to a predetermined specification, indicated by block 56 in FIG. 2. The refurbishing and/or repairing step 56 may include removing deposits from the component, applying a coating to the component, annealing the component, and/or machining a dimension of the component, depending on the particular component involved. For example, in the case of a rotating bucket 42 or stationary nozzle 44 included in a turbine 16, the refurbishing and/or repairing step 56 may include performing an acid wash of the bucket 42 or nozzle 44 to remove any corrosion products or other buildup on the outer surface of the component. The bucket 42 or nozzle 44 may then be welded, machined, or otherwise refurbished to restore the component to desired dimensions, heat treated to anneal any defects, and/or coated with a new thermo-barrier coating before being returned to service.

At any time during the refurbishing/repairing step 56, additional information about the component may be discovered that requires a return to the comparison block 52 to determine if an extended service life is allowed, as indicated by loop 58. For example, an additional defect discovered in the component during the refurbishment/repair step 56 may result in a previously satisfied predetermined departure parameter no longer being satisfied. As a result, the method returns to the comparison step 52 to determine if an extended service life is still permitted or not.

At block 60, an extended service life may be established for the component to allow the component to remain in service beyond the service life. The extended service life may or may not be expressed in the same parameter(s) as the service life and may include one or more combinations of defined or undefined intervals, reduced operating limits, increased maintenance or inspections, and/or additional monitoring of the component, depending on various factors. For example, in particular embodiments, the extended service life may simply allow continued operations for one or more additional intervals (e.g., a specific number of additional operating hours, startups, shutdowns, refurbishments, etc.) previously defined by the service life. Alternately or in addition, the extended service life may include one or more operating, repair, or maintenance limitations on the gas turbine once the component reaches the service life. For example, the extended service life may be for a defined number of additional operating hours, but the gas turbine may be limited to a reduced maximum operating temperature and/or power level while the component is operated beyond the service life. As another example, the extended service life may be for an undefined period or interval (e.g., an unlimited number of additional operating hours, startups, shutdowns, refurbishments, etc.), but additional inspections and/or maintenance of the component may be required during each shutdown. As a still further example, the extended service life may be for a defined or an undefined period or interval, but additional monitoring of the component may be required during operations, and if the component reaches a predetermined limit indicative of imminent or impending failure, the extended service life may be terminated, requiring prompt shutdown of the gas turbine to prevent damage to the gas turbine.

Once the refurbishing/repairing step 56 is completed and the extended service life is determined 60, the component may be returned to service and operated according to the extended service life, as indicated by block 62. As the component reaches the extended service life, the method may return to the comparison block 52 to determine if another extended service life is allowed, as indicated by loop 64. Alternately, the method may proceed with removal of the component from service and inspection of the component represented by block 66 to determine or validate the extended service life of the component. When a sufficient number of the same components have been operated beyond their service lives, the extended service lives established in block 60 and/or the inspections and validations performed in block 66 may provide a basis for revising the service life for those components, as indicated by block 68. The revised service life may then replace the existing or current service life for those components.

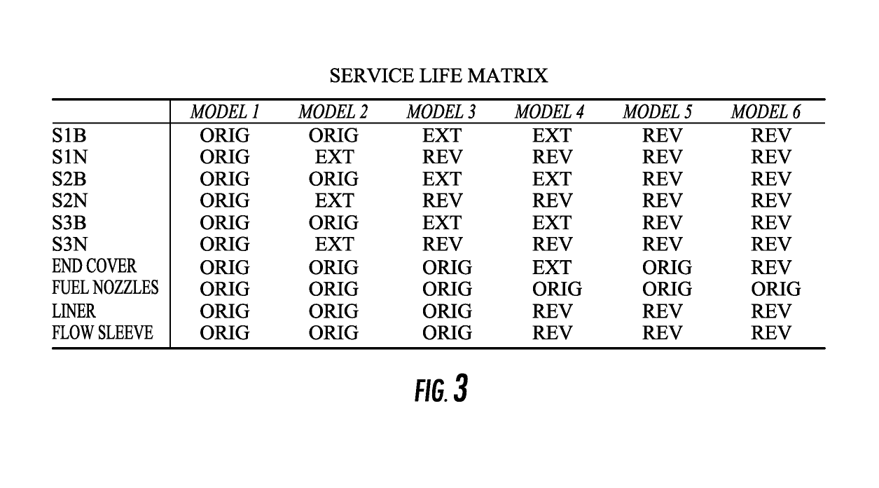

FIG. 3 provides an exemplary service life matrix for gas turbine components according to various embodiments of the present invention. The columns represent six different gas turbine models, and the rows represent a specific component in each model. The exemplary gas turbine represented by Model 1 is a relatively new gas turbine model in which none of the listed components have reached a service life. As a result, the ORIG in the matrix indicates that each component is operating under the original service life for that component.

The exemplary gas turbine represented by Model 2 is older than the Model 1 gas turbine, but the Model 2 gas turbine did not have many units in service. Referring to the column for Model 2, the rotating buckets (S1B, S2B, S3B), end cover, fuel nozzles, liner, and flow sleeve are still operating under their original service lives. This may be because these components have either not yet reached their original service lives or because they have already been taken out of service and replaced with new components. In contrast, the stationary nozzles (S1N, S2N, S3N) have already approached or exceeded their service lives, and the EXT in the matrix indicates that each stationary nozzle is operating under an extended service life established according to the method previously described with respect to FIG. 2. Notably, the revised service life described in FIG. 2 is not yet available for the stationary nozzles due to the small number of units in service and/or other insufficient available data to revise the service life for each stationary nozzle.

The exemplary gas turbine represented by Model 3 is older than the Model 2 gas turbine, and the Model 3 gas turbine has many more units in service compared to the Model 2 gas turbine. Referring to the column for Model 3, the end cover, fuel nozzles, liner, and flow sleeve are still operating under their original service lives, again because these components have either not yet reached their original service lives or because they have already been taken out of service and replaced with new components. In contrast, the stationary nozzles (S1N, S2N, S3N) and rotating buckets (S1B, S2B, S3B) have already approached or exceeded their service lives. The EXT in the matrix indicates that each rotating bucket is operating under an extended service life established according to the method previously described with respect to FIG. 2, but there is not yet sufficient data to establish a revised service life for the rotating buckets. However, the REV in the matrix indicates that each stationary nozzle has previously received a revised service life according to the method previously described with respect to FIG. 2.

The exemplary gas turbine represented by Model 4 is the same age as the Model 3 gas turbine, but the Model 4 gas turbine includes an older version of the end cover, liner, and flow sleeve. Referring to the column for Model 4, the fuel nozzles are still operating under the original service life, again because the fuel nozzles have either not yet reached the original service life or because they have already been taken out of service and replaced with new fuel nozzles. In contrast, the stationary nozzles (S1N, S2N, S3N) and rotating buckets (S1B, S2B, S3B) have established extended or revised service lives as previously described with respect to the Model 3 gas turbine. The EXT in the matrix for the end cover indicates that the end cover is operating under an extended service life established according to the method previously described with respect to FIG. 2, but there is not yet sufficient data to establish a revised service life for the end cover. The REV in the matrix for the liner and the flow sleeve indicates that the liner and flow sleeve have each previously received a revised service life according to the method previously described with respect to FIG. 2.

The exemplary gas turbine represented by Model 5 is older than the Model 3 gas turbine; however, the Model 5 gas turbine includes a newer version of the end cover. Referring to the column for Model 5, the end cover and fuel nozzles are still operating under the original service lives because the end cover has not yet reached the original service life and the fuel nozzles have already been taken out of service and replaced with new fuel nozzles. In contrast, the stationary nozzles (S1N, S2N, S3N), rotating buckets (S1B, S2B, S3B), liner, and flow sleeve have established revised service lives based on previous extended service lives and/or sufficient data to establish revised service lives as previously described with respect to the method shown in FIG. 2.

The exemplary gas turbine represented by Model 6 is the oldest gas turbine model in the matrix, with many units in service. Referring to the column for Model 6, the fuel nozzles are still operating under the original service life because the original fuel nozzles have already been taken out of service and replaced with new fuel nozzles. In contrast, all of the other components have established revised service lives based on previous extended service lives and/or sufficient data to establish revised service lives as previously described with respect to the method shown in FIG. 2.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A method for extending a service life of a gas turbine component, comprising:
a. identifying the service life for the component;
b. comparing a characteristic of the component to a predetermined departure parameter;
c. refurbishing the component to a predetermined specification if the characteristic of the component satisfies the predetermined departure parameter; and
d. establishing an extended service life for the component.

2. The method as in claim 1, wherein the service life for the component comprises at least one of operating hours, startup events, shut down events, or refurbishment events.

3. The method as in claim 1, wherein the predetermined departure parameter includes at least one of a location of the component, a repair history of the component, a dimension of the component, an operating history of the gas turbine, or a repair history of the gas turbine.

4. The method as in claim 1, wherein the refurbishing comprises at least one of removing deposits from the component, applying a coating to the component, annealing the component, or machining a dimension of the component.

5. The method as in claim 1, further comprising establishing a revised service life for the component based on the extended service life for a plurality of components.

6. The method as in claim 1, further comprising inspecting the component after the component exceeds the service life.

7. The method as in claim 6, further comprising establishing a revised service life for the component based on the inspection of the component after the component exceeds the service life.

8. The method as in claim 1, further comprising comparing a plurality of characteristics of the component to a plurality of predetermined departure parameters.

9. The method as in claim 8, further comprising refurbishing the component to the predetermined specification if all of the plurality of characteristics of the component satisfy the plurality of predetermined departure parameters.

10. A method for extending a service life of a gas turbine component, comprising:
a. identifying the service life for the component;
b. comparing a plurality of characteristics of the component to a plurality of predetermined departure parameters;
c. refurbishing the component to a predetermined specification if no more than one of the plurality of characteristics of the component fails to satisfy the plurality of predetermined departure parameters; and
d. establishing an extended service life for the component.

11. The method as in claim 10, wherein the service life for the component comprises at least one of operating hours, startup events, shut down events, or refurbishment events.

12. The method as in claim 10, wherein the plurality of predetermined departure parameters include at least two of a location of the component, a repair history of the component, a dimension of the component, an operating history of the gas turbine, or a repair history of the gas turbine.

13. The method as in claim 10, wherein the refurbishing comprises at least one of removing deposits from the component, applying a coating to the component, annealing the component, or machining a dimension of the component.

14. The method as in claim 10, further comprising establishing a revised service life for the component based on the extended service life for a plurality of components.

15. The method as in claim 10, further comprising inspecting the component after the component exceeds the service life.

16. The method as in claim 15, further comprising establishing a revised service life for the component based on the inspection of the component after the component exceeds the service life.

17. The method as in claim 10, further comprising refurbishing the component to the predetermined specification if all of the plurality of characteristics of the component satisfy the plurality of predetermined departure parameters.
